(19) United States
(12) Patent Application Publication
(10) Pub. No.: US 2020/0389041 A1
(43) Pub. Date: Dec. 10, 2020

(54) BATTERY PROTECTION SYSTEMS

(71) Applicant: O2Micro Inc., Santa Clara, CA (US)

(72) Inventors: Guoxing LI, Sunnyvale, CA (US); Yan LI, Wuhan (CN)

(21) Appl. No.: 16/869,454

(22) Filed: May 7, 2020

(30) Foreign Application Priority Data
Jun. 5, 2019 (CN) 201910486111.0

(51) Int. Cl. H02J 7/00

(52) U.S. Cl. CPC H02J 7/00308; H02J 7/00304; H02J 7/0047

(57) ABSTRACT

A threshold setting circuit includes a temperature reference multiplexer, a temperature comparison circuit, and a threshold multiplexer. The temperature reference multiplexer outputs a reference signal of a set of reference signals. The temperature comparison circuit compares a signal indicative of a temperature of a battery with the reference signals output from the temperature reference multiplexer to generate a set of result signals. The threshold multiplexer selects one or more protection thresholds from a set of protection thresholds according to the result signals. The one or more protection thresholds are used to determine whether the battery is in an abnormal condition.

### REFERENCE TO RELATED APPLICATION

This application claims benefit under 35 U.S.C. § 119(a) to Application No. 201910486111.0, filed with the State Intellectual Property Office of the People's Republic of China on Jun. 5, 2019, hereby incorporated herein by reference in its entirety.

### BACKGROUND

FIG. 1 illustrates a diagram showing relationships between battery temperature and over-voltage threshold V_{OV}, and between battery temperature and over-current threshold I_{OC}, in a conventional battery protection system. The over-voltage threshold V_{OV} and the over-current threshold I_{OC} are used to protect a rechargeable battery in the battery protection system. For example, during a charging process of the battery, if a battery voltage of the battery is greater than the over-voltage threshold V_{OV}, then the battery voltage is considered too high, and the battery protection system terminates the charging of the battery. Similarly, if a charging current of the battery is greater than the over-current threshold I_{OC}, then the charging current is considered too large, and the battery protection system terminates the charging of the battery. As a result, the battery protection system can protect the battery from over-voltage and/or over-current conditions. As shown in FIG. 1, if the battery temperature is less than T_{C} (e.g., 0° C.), then the battery temperature is considered too low; if the battery temperature is greater than T_{H} (e.g., 40° C., 41° C., 45° C., or the like), then the battery temperature is considered too high. In both situations, the battery protection system prohibits the charger (not shown) from charging the battery. If the battery temperature is between T_{C} and T_{H}, then the battery temperature is considered normal, and the battery protection system allows the charger to charge the battery and sets the over-voltage threshold V_{OV} and the over-current threshold I_{OC} to V_{TH} and I_{TH}, respectively.

However, the conventional battery protection system of FIG. 1 decides whether to charge the battery simply by determining whether the battery temperature is too low or too high. When the battery temperature is considered normal, the conventional battery protection system sets a single over-voltage threshold and a single over-current threshold to protect the battery. This conventional battery protection system may not be able to provide reliable protection for the battery. In addition, deciding whether to charge the battery based on only a single over-voltage threshold and a single over-current threshold may reduce the charging efficiency of the battery, because batteries in different applications may have different temperature characteristics. In other words, in some practical situations, the maximum safe charging power of a battery can change if the battery temperature changes. For example, in a laptop, if a battery has a temperature ranged from 10° C. to 45° C., then the battery can be charged normally, and the battery's over-voltage threshold can be set to a higher level (e.g., 4.25V). If the battery temperature is ranged from 0° C. to 10° C., then the battery can still be allowed to be charged, and its over-voltage threshold is lower (e.g., 4.2V). However, the conventional battery protection system provides a single over-voltage threshold to protect the battery when it is determined that the battery is allowed to be charged, e.g., the battery temperature is within a chargeable temperature range. If the chargeable temperature range is set to be larger, e.g., 0° C. to 45° C., and the over-voltage threshold is set to be higher, e.g., 4.25V, then the battery is not reliably protected when the battery temperature is in the range between 0° C. to 10° C.; if the chargeable temperature range is set to be larger, e.g., 0° C. to 45° C., and the over-voltage threshold is set to be lower, e.g., 4.2V, then when the battery temperature is in the range from 10° C. to 45° C., the charging efficiency of the battery is over-limited and cannot be maximized; and if the chargeable temperature range is set to be smaller, e.g., 10° C. to 45° C., and the over-voltage threshold is set to be higher, e.g., 4.25V, then when the battery temperature is in the range from 0° C. to 10° C., the battery is not charged although the battery is allowed to be charged, which reduces the charging efficiency of the battery. Thus, the conventional battery protection system may not be able to provide reliable protection to the battery in the laptop, and/or may lower the charging efficiency of the battery.

### SUMMARY

In embodiments, a threshold setting circuit includes a temperature reference multiplexer, a temperature comparison circuit, and a threshold multiplexer. The temperature reference multiplexer outputs a reference signal of a set of reference signals. The temperature comparison circuit compares a signal indicative of a temperature of a battery with the reference signals output from the temperature reference multiplexer to generate a set of result signals. The threshold multiplexer selects one or more protection thresholds from a set of protection thresholds according to the result signals. The one or more protection thresholds are used to determine whether the battery is in an abnormal condition.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a diagram of relationships between battery temperature and over-voltage threshold, and between battery temperature and over-current threshold, in a conventional battery protection system.

FIG. 2 illustrates a block diagram of an example of a battery protection system, in an embodiment of the present invention.

FIG. 3 illustrates a block diagram of an example of a battery protection system that includes a threshold setting circuit, in an embodiment of the present invention.

FIG. 4 illustrates a diagram of an example of a time sequence for setting a protection threshold, in an embodiment of the present invention.

FIG. 5 illustrates a diagram of relationships between battery temperature and over-voltage threshold, and between battery temperature and over-current threshold in an example of a battery protection system, in an embodiment of the present invention.

FIG. 6 illustrates waveforms for examples of signals, in a threshold setting circuit, that change as a battery temperature changes, in an embodiment of the present invention.

FIG. 7 illustrates a block diagram of an example of a battery protection system that includes a threshold setting circuit, in an embodiment of the present invention.

FIG. 8 illustrates a diagram of relationships between battery temperature and over-voltage threshold, and between battery temperature and over-current threshold, in an example of a battery protection system in an embodiment of the present invention.

FIG. 9 illustrates an example of a method for protecting a battery, in an embodiment of the present invention.

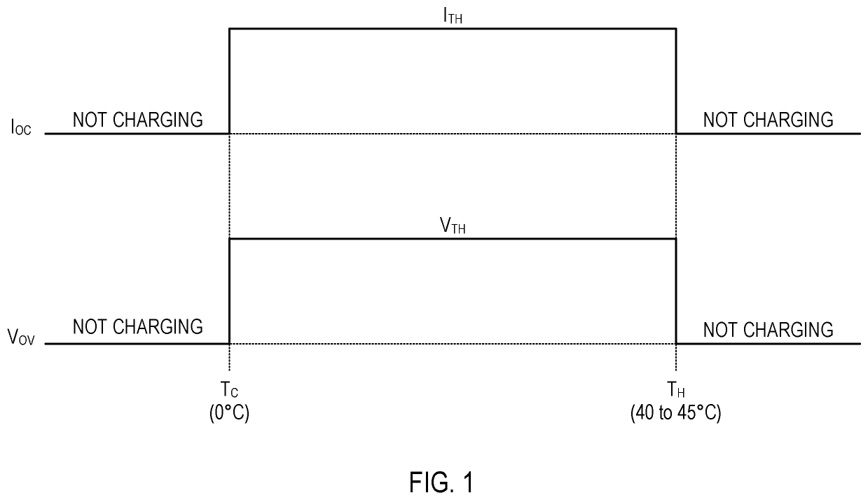

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention provide a battery protection system with a protection threshold setting function. In embodiments, a threshold setting circuit sets a protection threshold (e.g., including an over-voltage threshold and/or an over-current threshold) for protecting the battery according to a temperature range that the battery is in. As a result, the battery is reliably protected in different temperature ranges, and the charging efficiency of the battery is improved.

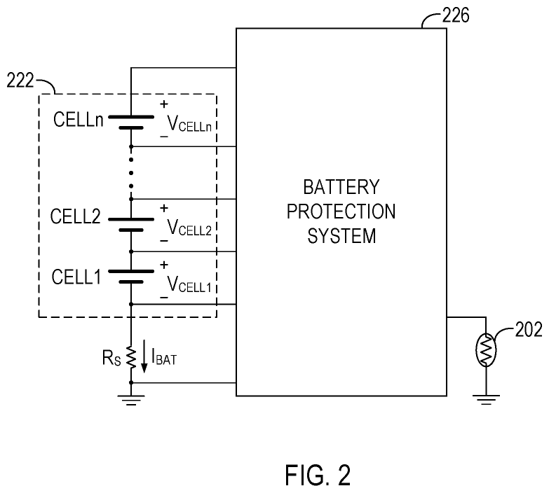

FIG. 2 illustrates a block diagram of an example of a battery protection system 226, in an embodiment of the present invention. As shown in FIG. 2, the battery protection system 226 is coupled to a battery 222, and provides protection for the battery 222. The battery 222 can include one or more rechargeable battery cells Cell1-Celln (n is a natural number). The rechargeable battery cells can include, but are not limited to, lithium-ion batteries. The battery protection system 226 uses a temperature sensor 202 (e.g., including a thermistor with a negative temperature coefficient), to determine which temperature range the battery 222 is in, and sets a protection threshold to a value corresponding to the temperature range. The protection threshold can be an over-voltage threshold V_{OV} of the battery cells Cell1-Celln or an over-current threshold boy of the battery 222. The over-voltage threshold V_{OV} is used to determine whether voltages V_{CELL1}, V_{CELL2}, . . . , V_{CELLn} of the battery cells Cell1-Celln are within a safe range. If a battery cell's voltage is greater than the over-voltage threshold V_{OV}, then the battery cell's voltage is considered to be too high, and the battery protection system 226 prohibits/stops charging of the battery 222. Similarly, the over-current threshold I_{OV} is used to determine whether a current I_{BAT} (e.g., a charging current) of the battery 222 is within a safe range. If the battery current I_{BAT} is greater than the over-current threshold I_{OC}, then the battery current I_{BAT} is considered to be too large, and the battery protection system 226 prohibits/stops charging of the battery 222.

More specifically, the battery protection system 226 includes a threshold setting circuit and a protection circuit. The threshold setting circuit can determine which temperature range the battery 222 is in, and set a protection threshold based on the temperature range. The protection circuit compares the protection threshold with a battery parameter (e.g., a battery cell voltage or a battery current) to determine whether the battery 222 is in an abnormal condition (e.g., an over-voltage condition or an over-current condition). If it is determined that the battery 222 is in an abnormal condition, then the battery protection system 226 protects the battery 222 by, e.g., stopping the charging of the battery 222. For example, the battery protection system 226 can turn off a charging switch (not shown) that is used to charge the battery 222. More specifically, in an embodiment, a charging switch (not shown) is coupled between the battery 222 and a power input terminal that is used to receive a charging current from a charger (not shown). When the charging switch is on, a charging current from the charger can flow through the charging switch to charge the battery 222. When the charging switch is off, the charging current is disabled. If it is determined that the battery 222 is in an abnormal condition, then the battery protection system 226 can protect the battery 222 by turning off the charging switch. In an embodiment, the charging switch can include a metal-oxide-semiconductor field-effect transistor (MOSFET). The battery protection system 226 can generate a protection signal, e.g., a signal S_{OV} or S_{OC} mentioned below, to control a gate terminal of the MOSFET, thereby turning on or off the MOSFET. However, the invention is not so limited.

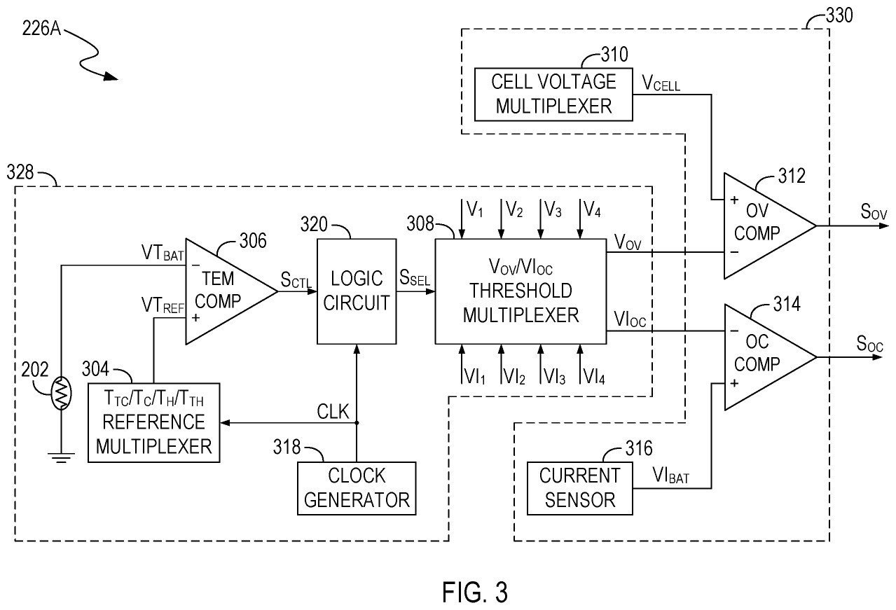

FIG. 3 illustrates a block diagram of an example of a battery protection system 226A that includes a threshold setting circuit and a protection circuit, in an embodiment of the present invention. FIG. 3 is described in combination with FIG. 2. As shown in FIG. 3, the battery protection system 226A includes a threshold setting circuit 328 and a protection circuit 330. The threshold setting circuit 328 includes a temperature sensor 202, a temperature reference multiplexer 304, a temperature comparison circuit 306, a logic circuit 320, a threshold multiplexer 308, and a clock generator 318. The protection circuit 330 includes a cell voltage multiplexer 310, a current sensor 316, and an abnormality detection circuit. The abnormality detection circuit includes an over-voltage comparator 312 and can also include an over-current comparator 314.

In an embodiment, the temperature reference multiplexer 304 outputs a reference signal VT_{REF} of a set of reference signals sequentially in a preset order, as described below. In the example of FIG. 3, the set of reference signals includes voltage references VT_{TC}, VT_{C}, VT_{H}, and VT_{TH}, respectively indicative of (or corresponding to) temperature values T_{TC}, T_{C}, T_{H}, and T_{TH}; however, the invention is not limited to four temperature values. The relationship between the temperature values T_{TC}, T_{C}, T_{H} and T_{TH} is as follows: T_{TC}<T_{C}<T_{H}<T_{TH}. In an embodiment, the temperature value T_{TC} means “too cold”, the temperature value T_{C} means “cold”, the temperature value T_{H} means “hot”, and the temperature value T_{TH} means “too hot.” In an embodiment, the voltage references VT_{TC}, VT_{C}, VT_{H}, and VT_{TH} are provided by a thermistor 202 with a negative temperature coefficient. Thus, the relationship between the voltage references VT_{TC}, VT_{C}, VT_{H}, and VT_{TH} is as follows: VT_{TC}>VT_{C}>VT_{H}>VT_{TH}. In an embodiment, the temperature reference multiplexer 304 outputs the reference signals VT_{TC}, VT_{C}, VT_{H}, and VT_{TH} sequentially in a preset order. For example, the preset order of outputting the reference signals can be VT_{TC}, VT_{C}, VT_{H}, and VT_{TH}. For another example, the preset order can be VT_{TH}, VT_{H}, VT_{C}, and VT_{TC}. For yet another example, the preset order can be VT_{TC}, VT_{TH}, VT_{C}, and VT_{H}. However, the invention is not limited to these examples.

The temperature comparison circuit 306 compares a sensing signal VT_{BAT} (e.g., a voltage signal from the thermistor 202) that is indicative of the temperature T_{BAT} of the battery 222 with the reference signals VT_{REF} (e.g., including VT_{TC}, VT_{C}, VT_{H}, and VT_{TH}) output from the temperature reference multiplexer 304, and generates a set of result signals S_{CTL} to indicate a temperature range that the battery 222 is in. The result signals S_{CTL} can include a set of digital signals. In the example of FIG. 3, the positive input terminal of the temperature comparison circuit 306 receives the reference signal VT_{REF}, and the negative input terminal of the temperature comparison circuit 306 receives the temperature sensing signal VT_{BAT}. Thus, if the battery temperature T_{BAT} is greater than the temperature T_{REF} indicated by the reference signal VT_{REF}, then the temperature sensing signal VT_{BAT} is less than the reference signal VT_{REF}, and the temperature comparison circuit 306 outputs a digital signal “1” (e.g., a logic-high signal); or if the battery temperature T_{BAT} is lower than the temperature T_{REF} indicated by the reference signal VT_{REF}, then the temperature sensing signal VT_{BAT} is greater than the reference signal VT_{REF}, and the temperature comparison circuit 306 outputs a digital signal “0” (e.g., a logic-low signal). The temperature comparison circuit 306 compares the sensing signal VT_{BAT} with the reference signals VT_{TC}, VT_{C}, VT_{H}, and VT_{TH}, sequentially, thereby generating a set of result signals S_{CTL} (e.g., digital signals 1000, 1100, or the like) to indicate a temperature range that the battery 222 is in. Taking FIG. 3 as an example, if the result signals S_{CTL} include digital signals 0000, then it indicates that the battery temperature T_{BAT} is less than T_{TC}; if the result signals S_{CTL} include digital signals 1000, then it indicates that the battery temperature T_{BAT} is in the range from T_{TC} to T_{C}; if the result signals S_{CTL} include digital signals 1100, then it indicates that the battery temperature T_{BAT} is in the range from T_{C} to T_{H}; if the result signals S_{CTL} include digital signals 1110, then it indicates that the battery temperature T_{BAT} is in the range from T_{H} to T_{TH}; or if the result signals S_{CTL} include digital signals 1111, then it indicates that the battery temperature T_{BAT} is greater than T_{TH}.

The logic circuit 320 receives the result signals S_{CTL} in series and converts the result signals S_{CTL} to a selection signal S_{SEL} that controls the threshold multiplexer 308. By way of example, the logic circuit 320 receives the result signals S_{CTL} (e.g., including a digital signal string of bits) in series, and converts the digital signal string S_{CTL} to a parallel digital signal S_{SEL} or to another type of selection signal S_{SEL}. Under the control of the selection signal S_{SEL}, the threshold multiplexer 308 selects one or more protection thresholds from a set of protection thresholds according to the result signals S_{CTL}. The one or more protection thresholds are used to determine whether the battery 222 is in an abnormal condition. In an embodiment, the set of protection thresholds includes multiple over-voltage thresholds V₁, V₂, V₃, and V₄. Each over-voltage threshold corresponds to one or more temperature ranges of a set of temperature ranges, and is used to determine whether a battery cell in the battery 222 is in an over-voltage condition. More specifically, the protection threshold selected by the threshold multiplexer 308 includes an over-voltage threshold V_{OV} (e.g., V₁, V₂, V₃, or V₄) of a battery cell in the battery 222 when the battery 222 is in a temperature range determined by the result signals S_{CTL}. In the example of FIG. 3, the over-voltage threshold V₁corresponds to a temperature range from T_{TC} to T_{C}; the over-voltage threshold V₂ corresponds to a temperature range from T_{C} to T_{H}; the over-voltage threshold V₃ corresponds to a temperature range from T_{H} to T_{TH}; and the over-voltage threshold V₄ corresponds to a temperature range below T_{TC} and a temperature range above T_{TH}. In an embodiment, the cell voltage multiplexer 310 outputs a cell voltage V_{CELL} of a battery cell in the battery 222. If the battery cell voltage V_{CELL} is greater than the threshold V_{OV}, it indicates that the battery cell is in an over-voltage condition. In another embodiment, the cell voltage multiplexer 310 outputs a signal indicative of a battery cell voltage V_{CELL} (e.g., proportional to the battery cell voltage V_{CELL}), and the threshold multiplexer 308 outputs a threshold signal V_{OV} indicative of an over-voltage threshold of the battery cell (e.g., proportional to the over-voltage threshold). If the signal output from the cell voltage multiplexer 310 is greater than the threshold V_{OV}, it indicates that the battery cell is in an over-voltage condition.

In an embodiment, the set of protection thresholds also includes multiple over-current thresholds I₁, I₂, I₃, and I₄. Each over-current threshold corresponds to one or more temperature ranges of a set of temperature ranges, and is used to determine whether the battery 222 is in an over-current condition. More specifically, the protection threshold selected by the control threshold multiplexer 308 can include an over-current threshold I_{OC} (e.g., I₁, I₂, I₃, or I₄) of the battery 222 when the battery 222 is in a temperature range determined by the result signals S_{CTL}. In the example of FIG. 3, the over-current threshold I₁ corresponds to the temperature range from T_{TC} to T_{C}; the over-current threshold I₂ corresponds to the temperature range from T_{C} to T_{H}; the over-current threshold I₃ corresponds to the temperature range from T_{H} to T_{TH}; and the over-current threshold I₄ corresponds to a temperature range below T_{TC} and a temperature range above T_{TH}. In an embodiment, a signal VI_{BAT} provided from the current sensor 316 is a voltage signal indicative of (e.g., proportional to) the battery current I_{BAT}. In an embodiment, the threshold multiplexer 308 receives voltage signals VI₁, VI₂, VI₃, and VI₄, and outputs a voltage signal VI_{OC} according to a temperature range determined by the result signals S_{CTL}. The voltage signals VI₁, VI₂, VI₃, and VI₄ are respectively indicative of (e.g., proportional to) the over-current thresholds I₁, I₂, I₃, and I₄, and the voltage signal VI_{OC} is indicative of (e.g., proportional to) the over-current threshold I_{OC}. If the battery current I_{BAT} is greater than the over-current threshold I_{OC} (e.g., the signal VI_{BAT} provided from the current sensor 316 is greater than the voltage signal VI_{OC}), then it indicates that the battery 222 is in an over-current condition. However, the present invention is so limited. In another embodiment, the signal output by the current sensor 316 may be another type of signal, e.g., a current signal I′_{BAT}, indicative of the battery current I_{BAT}. The threshold multiplexer 308 can receive current signals that have current levels proportional to I₁, I₂, I₃, and I₄, and can then output, according to the result signals S_{CTl}, a current signal that has a current level proportional to the current threshold I_{OC}. If the current signal I′_{BAT} output from the current sensor 316 is greater than the current signal output from the threshold multiplexer 308, it indicates that the battery 222 is in an over-current condition.

Additionally, the abnormality detection circuit in the protection circuit 330 can receive a protection threshold (e.g., an over-voltage threshold or an over-current threshold) output from the threshold multiplexer 308, and compare the protection threshold and a battery parameter (e.g., a battery cell voltage or a battery current) to generate a comparison result. The comparison result indicates whether the battery is in an abnormal condition. For example, the abnormality detection circuit includes an over-voltage comparator 312. The over-voltage comparator 312 compares a battery cell voltage with an over-voltage threshold, e.g., by comparing a signal V_{CELL} that is output from the cell voltage multiplexer 310 with a signal V_{OV} that is output from the threshold multiplexer 308, to generate a protection signal S_{OV}. If a battery cell in the battery 222 has a voltage greater than the over-voltage threshold, then the protection signal S_{OV} notifies the battery protection system to protect the battery 222, e.g., by turning off a charging switch that is used to charge the battery 222. The abnormality detection circuit can further include an over-current comparator 314. The over-current comparator 314 compares a battery current I_{BAT} with an over-current threshold I_{OV}, e.g., by comparing a signal VI_{BAT} provided by the current sensor 316 with a signal VI_{OC} that is output from the threshold multiplexer 308, to generate a protection signal S_{OC}. If the battery current I_{BAT} of the battery 222 is greater than the over-current threshold I_{OV}, then the protection signal S_{OC} notifies the battery protection system 226 to protect the battery 222, e.g., by turning off the charging switch.

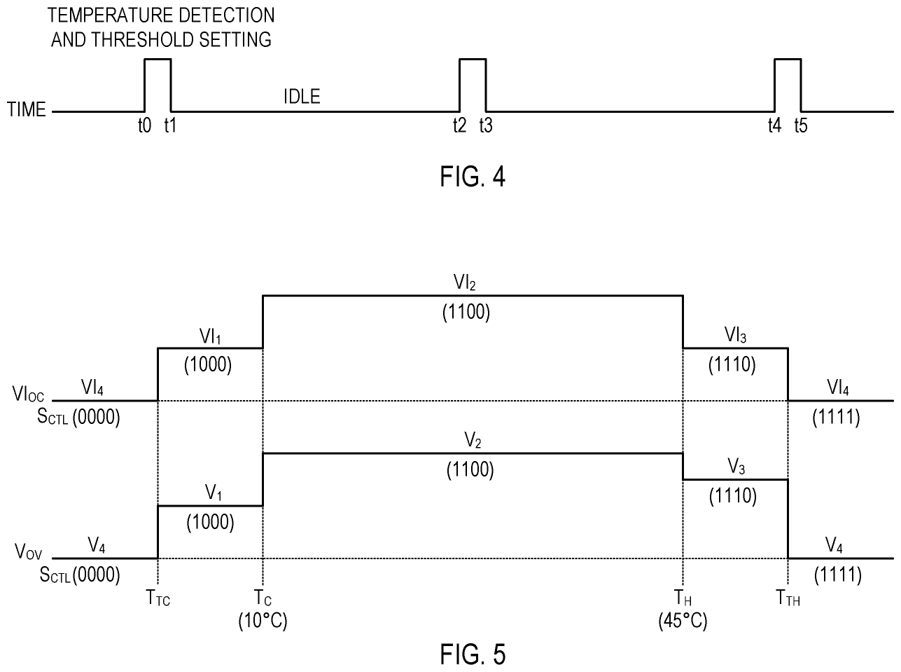

FIG. 4 illustrates a diagram of an example of a time sequence for setting a protection threshold, in an embodiment of the present invention. FIG. 4 is described in combination with FIG. 2 and FIG. 3. In the example of FIG. 4, the threshold setting circuit 328 periodically detects the battery temperature and sets/adjusts one or more protection thresholds (e.g., including an over-voltage threshold V_{OV} and/or an over-current threshold I_{OC}). For example, during time t0 and time t1, the threshold setting circuit 328 receives a sensing signal VT_{BAT}, indicative of the temperature of the battery 222, from the temperature sensor 202 to determine which temperature range the battery 222 is in, and sets a protection threshold according to the temperature range (e.g., by selecting an over-voltage threshold V_{OV} that corresponds to the temperature range from the over-voltage thresholds V₁, V₂, V₃, and V₄, and/or by selecting an over-current threshold I_{OC} that corresponds to the temperature range from the over-current thresholds I₁, I₂, I₃, and I₄). After the protection threshold is set, the threshold setting circuit 328 enters an idle mode for the time period between time t1 and time t2. In the idle mode, the threshold setting circuit 328 does not check the battery temperature and does not adjust the protection threshold, thereby reducing the power consumption of the battery protection system. When the threshold setting circuit 328 is in the idle mode, the protection circuit 330 compares battery parameters (e.g., including battery cell voltages V_{CELL1}, V_{CELL2}. . . and V_{CELLn}, and/or a battery current I_{BAT}) with corresponding protection thresholds (e.g., including an over-voltage threshold V_{OV} and/or an over-current threshold I_{OC}) to generate protection signals (e.g., S_{OV} and S_{OC}) to protect the battery 222. As shown in FIG. 4, from time t2 to t3, the threshold setting circuit 328 repeats the detection process for the battery temperature and the adjustment process for the protection threshold, and then enters the idle mode during time t3 and time t4. Thus, the threshold setting circuit 328 can periodically perform battery temperature detection and protection threshold adjustment. In an embodiment, since the battery temperature does not change abruptly, the duty cycle of the battery temperature detection and protection threshold adjustment (e.g., the ratio of the time interval from t0 to t1 to the time interval from t0 to t2) can be set to be relatively small to further reduce the power consumption of the battery protection system.

FIG. 5 illustrates a diagram showing relationships between battery temperature and over-voltage threshold V_{OV}, and between battery temperature and over-current threshold I_{OC} (e.g., represented by VI_{OC}), in an example of a battery protection system, in an embodiment of the present invention. In an embodiment, the relationship diagram shown in FIG. 5 is suitable for, but not limited to, a situation when a laptop's battery is being charged. FIG. 5 is described in combination with FIG. 2, FIG. 3, and FIG. 4.

In the example of FIG. 5, if the battery temperature T_{BAT} is lower than the T_{TC}, then the result signals S_{CTL} include digital signals 0000, the over-current threshold I_{OC} is set to I₄ (e.g., the voltage signal VI_{OC} is set to VI₄), and the over-voltage threshold V_{OV} is set to V₄. In an embodiment, the current value I₄ can be, but is not limited to, zero amperes. The voltage value V₄ can be, but is not limited to, zero volts. If the battery temperature T_{BAT} is in the range from T_{TC} to T_{C}, then the result signals S_{CTL} include digital signals 1000, the over-current threshold I_{OC} is set to I₁ (e.g., the voltage signal VI_{OC} is set to VI₁), and the over-voltage threshold V_{OV} is set to V₁. If the battery temperature T_{BAT} is in the range from T_{C} to T_{H}, then the result signals S_{CTL} include digital signals 1100, the over-current threshold I_{OC} is set to I₂ (e.g., the voltage signal VI_{OC} is set to VI₂), and the over-voltage threshold V_{OV} is set to V₂. If the battery temperature T_{BAT} is in the range from T_{H} to T_{TH}, then the result signals S_{CTL} include digital signals 1110, the over-current threshold I_{OC} is set to I₃ (e.g., the voltage signal VI_{OC} is set to VI₃), and the over-voltage threshold V_{OV} is set to V₃. If the battery temperature T_{BAT} is higher than T_{TH,}then the result signals S_{CTL} include digital signals 1111, the over-current threshold I_{OC} is set to I₄ (e.g., the voltage signal VI_{OC} is set to VI₄), and the over-voltage threshold V_{OV} is set to V₄.

More specifically, in the example of FIG. 5, if the battery temperature is in the range from T_{C} to T_{H}, then the battery temperature can be considered to be in a normal temperature range, and the battery 222 can work in a normal charging mode. In the normal charging mode, the upper limit V₂ of the battery cell voltages V_{CELL1}, V_{CELL2}, . . . V_{CELLn} can be relatively high (e.g., approximately equal to the full charge voltage of the battery cell), and the upper limit I₂ of the charging current I_{BAT} of the battery 222 (e.g., represented by VI₂) can also be relatively large. If the battery temperature is too low (e.g., lower than T_{TC}), or if the battery temperature is too high (e.g., higher than T_{TH}), then the battery 222 can be considered unsuitable for charging. Thus, the upper limit V₄ of the battery cell voltage and the upper limit I₄ of the charging current (e.g., represented by VI₄) are relatively small. If the battery temperature is in the range from T_{TC} to T_{C}, then it can indicate that the battery temperature is relatively low, but the battery can still be charged. Thus, the upper limit V₁ of the battery cell voltage is greater than V₄ and less than V₂ (V₄<V₁<V₂), and the upper limit I₁ of the charging current is greater than I₄ and less than I₂ (e.g., VI₄<VI₁<VI₂). If the battery temperature is in the range from T_{H} to T_{TH}, then it can indicate that the battery temperature is relatively high, but the battery can still be charged. Thus, the upper limit V₃ of the battery cell voltage is greater than V₄ and less than V₂ (V₄<V₃<V₂), and the upper limit of the charging current I₃ is greater than I₄ and less than I₂ (e.g., VI₄<VI₃<VI₂).

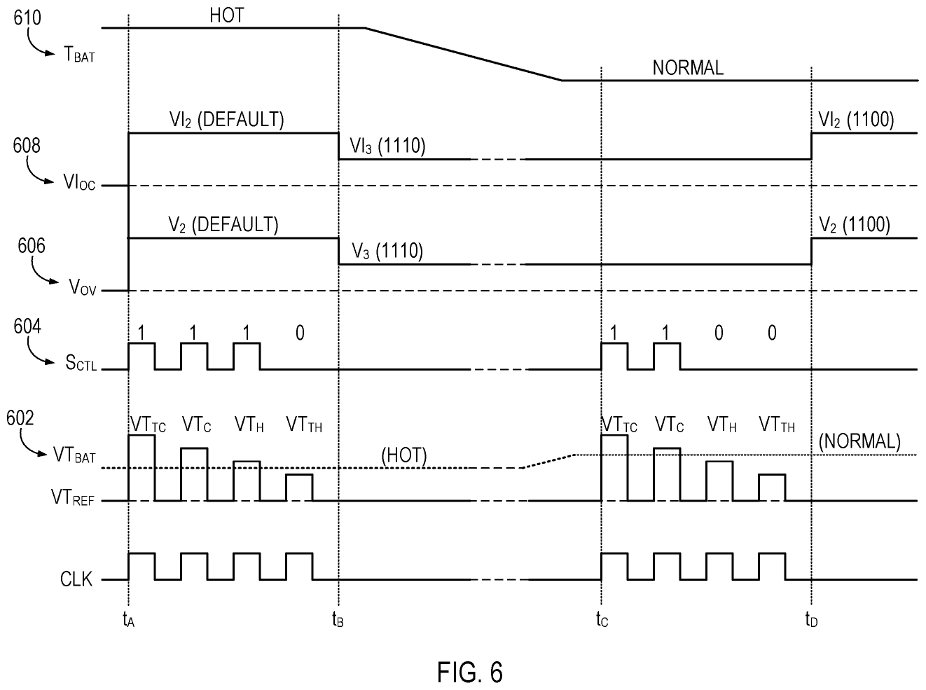

FIG. 6 illustrates waveforms for examples of signals, in the threshold setting circuit 328, that change as a battery temperature changes, in an embodiment of the present invention. The signals include VI_{OC}, V_{OV}, S_{CTL}, and VT_{BAT}, where VI_{OC} represents an over-current threshold selected by the threshold multiplexer 308, V_{OV} represents an over-voltage threshold selected by the threshold multiplexer 308, S_{CTL} represents a set of result signals (e.g., including a set of digital signals) output from the temperature comparison circuit 306, and VT_{BAT} represents a sense voltage on the temperature sensor 202. FIG. 6 is described in combination with FIG. 2, FIG. 3, FIG. 4 and FIG. 5.

As shown in the waveforms 602 and 610, between time t_{A} and time t_{B}, the battery is hot (e.g., the battery temperature T_{BAT} is relative high but not too high), and the temperature sensing signal VT_{BAT} is less than the reference VT_{H} and greater than the reference VT_{TH}. Thus, as shown in the waveform 604, the result signals S_{CTL} output from the temperature comparison circuit 306 include digital signals 1110. After time t_{B}, as shown in the waveforms 606 and 608, the threshold multiplexer 308 sets the over-voltage threshold V_{OV} and the over-current threshold VI_{OC} to the threshold V₃ and the threshold VI₃ respectively, where the thresholds V₃ and VI₃ correspond to the digital signals 1110. From time t_{C} to time t_{D}, the battery temperature T_{BAT} has dropped to a normal temperature range, and the temperature sensing signal VT_{BAT} is less than the reference VT_{C} and greater than the reference Vt_{H}. Thus, as shown in the waveform 604, the result signals S_{CTL}, output from the temperature comparison circuit 306 include digital signals 1100. After time t_{D}, as shown in the waveforms 606 and 608, the threshold multiplexer 308 sets the over-voltage threshold V_{OV} and the over-current threshold VI_{OC} to the threshold V₂ and the threshold VI₂ respectively, where the thresholds V₂ and VI₂ correspond to the digital signals 1100.

In the embodiments of FIG. 3, FIG. 5, and FIG. 6, the threshold setting circuit 328 compares the battery temperature T_{BAT} with four temperature values T_{TC}, T_{C}, T_{H}, and T_{TH,} e.g., by comparing the temperature sensing signal VT_{BAT} with the voltage references VT_{TC}, VT_{C}, VT_{H}, and VT_{TH}, and selects, according to results of the comparison, a threshold V_{OV} from four over-voltage thresholds V₁, V₂, V₃, and V₄, and a threshold VI_{OC} from four over-current thresholds VI₁, VI₂, VI₃, and VI₄. However, the present invention is not so limited. In other words, the number of temperature references, the number of the over-voltage thresholds, and the number of the over-current thresholds are not limited to four.

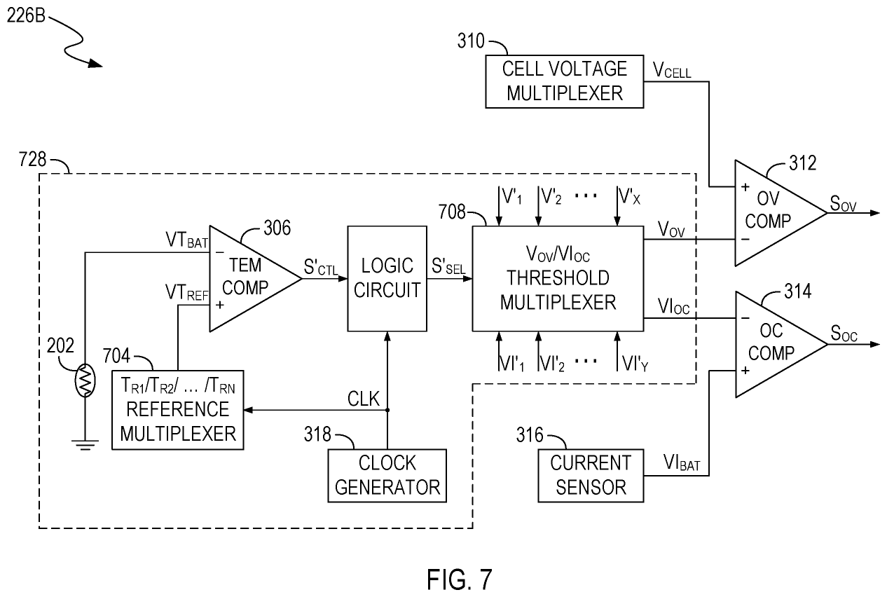

By way of example, a battery protection system 226B that includes a threshold setting circuit 728 is illustrated in FIG. 7, in another embodiment of the present invention. FIG. 7 is described in combination with FIG. 2, FIG. 3, FIG. 4, FIG. 5, and FIG. 6. As shown in FIG. 7, the threshold setting circuit 728 can compare the battery temperature T_{BAT} and N temperature references T_{R1}, T_{R2}, . . . , T_{RN} (N is a natural number), thereby selecting a corresponding over-voltage threshold V_{OV} from X over-voltage thresholds V′₁, V′₂, . . . , V′_{X} (X is a natural number), and selecting a corresponding over-current threshold VI_{OC} from Y over-current thresholds VI′₁, VI′₁, . . . , VI′₁ (Y is a natural number). The numbers N, X, and Y can be the same or different from one another.

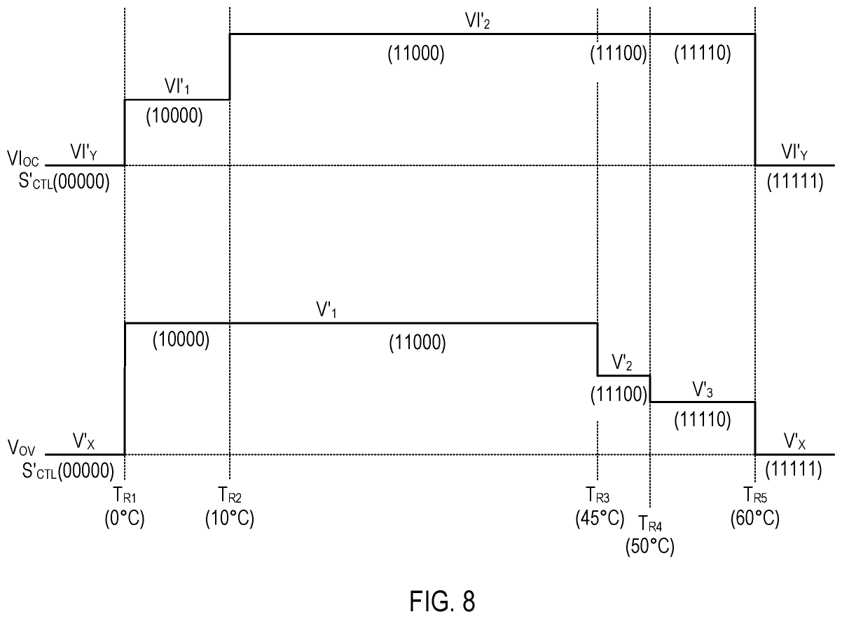

FIG. 8 illustrates a diagram showing relationships between battery temperature and over-voltage threshold V_{OV}, and between battery temperature and over-current threshold I_{OC} (e.g., represented by VI_{OC}), in an example of a battery protection system, in an embodiment of the present invention. In an embodiment, the relationship diagram shown in FIG. 8 is suitable for, but not limited to, a situation when a signal battery cell (e.g., a battery in a mobile phone) is being charged. FIG. 8 is described in combination with FIG. 7.

In the example of FIG. 8, the number N of the temperature references is five, the number X of the over-voltage thresholds is four, and the number Y of the over-current thresholds is three. If the battery temperature is lower than T_{R1} or higher than T_{R5}, then the battery is considered unsuitable for charging. Thus, the over-voltage threshold V′_{X} and the over-current threshold VI′_{Y} are set to be relatively small (e.g., zero volts and zero amperes, respectively). The over-voltage thresholds V′₁, V′₂, and V′₃ correspond to the temperature range from T_{R1} to T_{R3}, the temperature range from T_{R3} to T_{R4}, and the temperature range from T_{R4} to T_{R5}, respectively. The over-current thresholds VI′₁and VI′₂ correspond to the temperature range from T_{R1} to T_{R2}, and the temperature range from T_{R2} to T_{R5}, respectively. Thus, the threshold setting circuit 728 can set an appropriate protection threshold by determining which temperature range the battery is in.

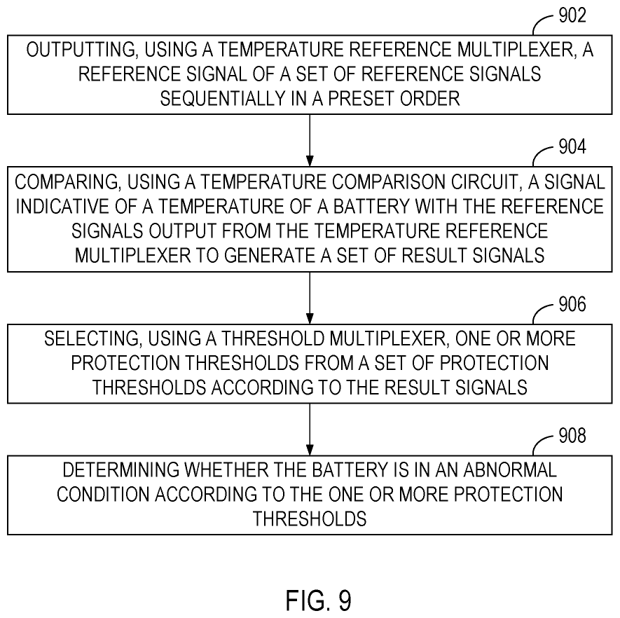

FIG. 9 illustrates an example of a method for protecting a battery, in an embodiment of the present invention. FIG. 9 is described in combination with FIG. 2, FIG. 3, FIG. 4, FIG. 5, FIG. 6, FIG. 7, and FIG. 8. Although specific steps are disclosed in FIG. 9, such steps are examples for illustrative purposes. That is, embodiments according to the present invention are well suited to performing various other steps or variations of the steps recited in FIG. 9.

At step 902, a temperature reference multiplexer (e.g., the multiplexer 304 in FIG. 3 or the multiplexer 704 in FIG. 7) sequentially outputs a set of reference signals VT_{REF} (e.g., including the voltage references VT_{TC}, VT_{C}, VT_{H}, and VT_{TH} corresponding to the temperature values T_{TC}, T_{C}, T_{H}, and T_{TH} in FIG. 3, or the voltage references VT_{R1}, VT_{R2}. . . VT_{RN} corresponding to the temperature values T_{R1}, T_{R2}. . . T_{RN} in FIG. 7).

At step 904, a temperature comparison circuit 306 compares a sensing signal VT_{BAT} indicative of a temperature T_{BAT} of the battery 222 with the reference signals VT_{REF} output from the temperature reference multiplexer to generate a set of result signals (e.g., S_{CTL} in FIG. 3 or S′_{CTL} in FIG. 7).

In step 906, a threshold multiplexer (e.g., the multiplexer 308 in FIG. 3 or the multiplexer 708 in FIG. 7) selects one or more protection thresholds from a set of protection thresholds according to the set of result signals (e.g., S_{CTL}, or S′_{CTL}). In the example of FIG. 3, the set of protection thresholds includes over-voltage thresholds V₁, V₂, V₃, and V₄, and/or over-current thresholds VI₁, VI₂, VI₃, and VI₄. In the example of FIG. 7, the set of protection thresholds includes over-voltage thresholds V′₁, V′₂, . . . , V′_{X}, and/or over-current thresholds VI′₁, VI′₂, . . . , VI′_{Y}.

At step 908, a protection circuit 330 determines whether the battery 222 is in an abnormal condition according to the selected one or more protection thresholds. Taking FIG. 3 as an example, if a battery cell's voltage V_{CELL} in the battery 222 is greater than the over-voltage threshold V_{OV} selected by the threshold multiplexer 308, then that battery cell is considered to be in an over-voltage condition. If a charging current I_{BAT} of the battery 222 is greater than the over-current threshold I_{OC} selected by the threshold multiplexer 308 (e.g., represented by the voltage signal VI_{OC}), then the battery 222 is considered to be in an over-current condition.

In summary, embodiments according to the present invention provide battery protection systems with a protection threshold setting or adjusting function. A threshold setting circuit in the battery protection system sequentially receives a set of reference signals indicative of a set of temperature values, and compares the received reference signals with a sensing signal indicative of a battery temperature to generate a set of result signals. Because the comparison process is relatively simple, it can be implemented by a comparison circuit that is relatively small and relatively inexpensive, thereby reducing the size of printed circuit board of the battery protection system and also reducing the cost of the system. In addition, the threshold setting circuit determines which temperature range the battery is in according to the result signals, and selects one or more protection thresholds from a set of protection thresholds (e.g., including a set of over-voltage thresholds and/or a set of over-current thresholds) corresponding to that temperature range. The battery protection system provides protection to the battery based on the selected protection threshold. Thus, compared to a conventional battery protection system, the battery protection system in an embodiment of the present invention can provide more reliable protection to the battery in different temperature ranges, and can improve the charging efficiency of the battery.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

We claim:

1. A threshold setting circuit comprising:
a temperature reference multiplexer that outputs a reference signal of a plurality of reference signals;
a temperature comparison circuit, coupled to said temperature reference multiplexer, that compares a signal indicative of a temperature of a battery with said plurality of reference signals output from said temperature reference multiplexer to generate a plurality of result signals; and
a threshold multiplexer, coupled to said temperature comparison circuit, that selects at least one protection threshold from a plurality of protection thresholds according to said plurality of result signals, wherein said at least one protection threshold is useful for determining whether said battery is in an abnormal condition.

2. The threshold setting circuit of claim 1, wherein said plurality of result signals indicates a temperature range that said battery is in, and said at least one protection threshold comprises an over-voltage threshold of a battery cell in said battery when said battery is in said temperature range.

3. The threshold setting circuit of claim 1, wherein said plurality of protection thresholds includes a plurality of over-voltage thresholds, and wherein each over-voltage threshold of said plurality of over-voltage thresholds corresponds to at least one temperature range of a plurality of temperature ranges, and is useful for determining whether a battery cell in said battery is in an over-voltage condition.

4. The threshold setting circuit of claim 1, wherein said plurality of result signals indicates a temperature range that said battery is in, and said at least one protection threshold comprises an over-current threshold of said battery when said battery is in said temperature range.

5. The threshold setting circuit of claim 1, wherein said plurality of protection thresholds includes a plurality of over-current thresholds, and wherein each over-current threshold of said plurality of over-current thresholds corresponds to at least one temperature range of a plurality of temperature ranges, and is useful for determining whether said battery is in an over-current condition.

6. The threshold setting circuit of claim 1, further comprising:
a logic circuit, coupled to said temperature comparison circuit and said threshold multiplexer, that receives said plurality of result signals in series and converts said plurality of result signals to a selection signal that controls said threshold multiplexer to select said at least one protection threshold from said plurality of protection thresholds.

7. A battery protection system comprising:
a threshold setting circuit operable for comparing a signal indicative of a temperature of a battery with a plurality of reference signals to generate a plurality of result signals to determine a temperature range that said battery is in, and operable for selecting at least one protection threshold from a plurality of protection thresholds according to said plurality of result signals; and
an abnormality detection circuit, coupled to said threshold setting circuit, operable for receiving said at least one protection threshold output from said threshold setting circuit, and comparing said at least one protection threshold with a battery parameter of said battery to generate a comparison result, wherein said comparison result indicates whether said battery is in an abnormal condition.

8. The battery protection system of claim 7, wherein said at least one protection threshold comprises an over-voltage threshold of a battery cell in said battery when said battery is in said temperature range.

9. The battery protection system of claim 7, wherein said plurality of protection thresholds includes a plurality of over-voltage thresholds, and wherein each over-voltage threshold of said plurality of over-voltage thresholds corresponds to at least one temperature range of a plurality of temperature ranges, and is useful for determining whether a battery cell in said battery is in an over-voltage condition.

10. The battery protection system of claim 7, wherein said at least one protection threshold comprises an over-current threshold of said battery when said battery is in said temperature range.

11. The battery protection system of claim 7, wherein said plurality of protection thresholds includes a plurality of over-current thresholds, and wherein each over-current threshold of said plurality of over-current thresholds corresponds to at least one temperature range of a plurality of temperature ranges, and is useful for determining whether said battery is in an over-current condition.

12. The battery protection system of claim 7, wherein said battery parameter comprises a voltage of a battery cell in said battery and said at least one protection threshold comprises an over-voltage threshold, and wherein said abnormality detection circuit comprises an over-voltage comparator that compares said voltage of said battery cell with said over-voltage threshold.

13. The battery protection system of claim 7, wherein said battery parameter comprises a current of said battery, and said at least one protection threshold comprises an over-current threshold, and wherein said abnormality detection circuit comprises an over-current comparison circuit that compares said current of said battery with said over-current threshold.

14. A method for protecting a battery, said method comprising:
outputting, using a temperature reference multiplexer, a reference signal of a plurality of reference signals sequentially in a preset order;
comparing, using a temperature comparison circuit, a signal indicative of a temperature of said battery with said plurality of reference signals output from said temperature reference multiplexer to generate a plurality of result signals;
selecting, using a threshold multiplexer, at least one protection threshold from a plurality of protection thresholds according to said plurality of result signals; and
determining whether said battery is in an abnormal condition according to said at least one protection threshold.

15. The method of claim 14, further comprising:
receiving, using a logic circuit, said plurality of result signals in series;
converting said plurality of result signals to a selection signal; and
controlling, using said selection signal, said threshold multiplexer to select said at least one protection threshold from said plurality of protection thresholds.

16. The method of claim 14, further comprising:
comparing said at least one protection threshold with a battery parameter of said battery to generate a comparison result, wherein said comparison result indicates whether said battery is in an abnormal condition.

17. The method of claim 16, wherein said plurality of result signals indicates a temperature range that said battery is in, wherein said at least one protection threshold comprises an over-voltage threshold of a battery cell in said battery when said battery is in said temperature range, and wherein said battery parameter comprises a voltage of said battery cell.

18. The method of claim 16, wherein said plurality of result signals indicates a temperature range that said battery is in, wherein said at least one protection threshold comprises an over-current threshold of said battery when said battery is in said temperature range, and wherein said battery parameter comprises a current of said battery.

19. The method of claim 14, wherein said plurality of protection thresholds comprises a plurality of over-voltage thresholds, and each over-voltage threshold of said plurality of over-voltage thresholds corresponds to at least one temperature range of a plurality of temperature ranges, and wherein said method further comprises:
determining whether a battery cell in said battery is in an over-voltage condition according to an over-voltage threshold of said plurality of over-voltage thresholds corresponding to a temperature range that said battery is in.

20. The method of claim 14, wherein said plurality of protection thresholds comprises a plurality of over-current thresholds, and each over-current threshold of said plurality of over-current thresholds corresponds to at least one temperature range of a plurality of temperature ranges, and wherein said method further comprises:
determining whether said battery is in an over-current condition according to an over-current threshold of said plurality of over-current thresholds corresponding to a temperature range that said battery is in.
